(19) United States
(12) Patent Application Publication
(10) Pub. No.: US 2022/0115921 A1
(43) Pub. Date: Apr. 14, 2022

(54) STATOR FOR AN ELECTRICAL MACHINE WITH IMPROVED PROTECTION AGAINST POTENTIAL DIFFERENCES BETWEEN ADJACENT STATOR COILS

(71) Applicant: Valeo Siemens eAutomotive Germany GmbH, Erlangen (DE)

(72) Inventors: Michael Mueller, Bad Neustadt a.d.Saale (DE); Michael Menz, Bad Neustadt a.d.Saale (DE)

(73) Assignee: Valeo Siemens eAutomotive Germany GmbH, Erlangen (DE)

(21) Appl. No.: 17/498,962

(22) Filed: Oct. 12, 2021

(30) Foreign Application Priority Data
Oct. 12, 2020 (DE) 10 2020 126 704.5

(51) Int. Cl. H02K 1/16; H02K 3/12; H02K 11/30

(52) U.S. Cl. CPC H02K 1/16; H02K 11/30; H02K 3/12

(57) ABSTRACT

A stator (5) for an electrical machine (1) is described, which comprises an annular stator base body (7) with stator grooves (13, 13a, 13b) which are open towards the inside, and stator coils (14a, 14b) of a stator winding (8) which are arranged in the stator grooves (13, 13a, 13b) and assigned to a plurality of phases (L1 . . . L3) of the electrical machine (1). Adjacent stator coils (14a, 14b) of the same phase (L1 . . . L3) are here contra-wound and electrically connected in parallel. Furthermore, an electrical machine (1) with such a rotor (3a . . . 3c), and a drive arrangement and a vehicle (17) with such an electrical machine (1) are described.

### TECHNICAL FIELD

A stator for an electrical machine is described, which comprises an annular stator base body with a plurality of stacked stator plates and stator grooves which are open towards the inside, and stator coils of a stator winding which are arranged in the stator grooves and are assigned to a plurality of phases of the electrical machine. Also disclosed is an electrical machine with a rotor which is mounted rotatably with respect to a stator of the abovementioned type about the rotation axis of the rotor. In addition, a drive arrangement is disclosed with an electrical machine of the abovementioned type, and a power supply connected to the stator winding, wherein the power supply is configured to supply electrical current to adjacent stator coils of the same phase which are electrically connected in parallel. Finally, a vehicle is disclosed with at least two axles, of which at least one is driven, wherein said drive is provided at least partially or for part of the time by the electrical machine of the above-mentioned type.

### PRIOR ART

A stator, an electrical machine, a drive arrangement and a vehicle of the above-mentioned type are known in principle from the prior art. In particular, the power supply to the drive arrangement may be formed by a converter which supplies electrical energy to the electrical machine from a battery or an accumulator. Ever faster-switching electronic switch elements (in particular, transistors) lead to voltage pulses with very high flank steepness. The high flank steepness leads sometimes to wave phenomena in the stator coils of the stator winding, in the sense that a flank of a voltage pulse propagating along the wires of adjacent parallel-connected stator coils may lead to a dangerous potential difference between the stator coils. This is a problem in particular on the end faces of the stator or at the winding head, since said wires can touch there and said potential difference may cause damage to the stator coils.

### DISCLOSURE OF THE INVENTION

It is therefore an object of the invention to provide an improved stator for an electrical machine, an improved electrical machine, an improved drive arrangement and an improved vehicle with such an electrical machine. In particular, a potential difference between adjacent stator coils of the same phase which are electrically connected in parallel is avoided even under rapid voltage pulses.

The object of the invention is achieved with a stator of the type cited initially in which adjacent stator coils of the same phase are contra-wound and electrically connected in parallel. Adjacent stator coils of the same phase thus have different winding directions, i.e. one of the adjacent stator coils winds to the left and the other to the right. In particular, also the respective radially inner connections and the respective radially outer connections of the adjacent stator coils of the same phase are electrically connected together. This means that the radially inner connection of a stator coil is connected then to the radially inner connection of an adjacent stator coil of the same phase, and the radially outer connection of the stator coil is connected to the radially outer connection of the adjacent stator coil of the same phase.

The object of the invention is also achieved with an electrical machine which comprises a stator and a rotor of the above-mentioned type, which is mounted so as to be rotatable relative to the stator about the rotational axis of the rotor.

The object of the invention is furthermore achieved with a drive arrangement which comprises an electrical machine of the abovementioned type and a power supply connected to the stator winding, wherein the power supply is configured to provoke a current flow with different winding direction (i.e. to the left and to the right) in the adjacent stator coils of the same phase which are contra-wound and electrically connected in parallel.

Finally, the object is also achieved by a vehicle with at least two axles, of which at least one is driven, wherein said drive is provided at least partially or for part of the time by the above-mentioned electrical machine.

By means of the proposed measures, the disadvantages cited initially may be overcome. In particular, the potential difference between adjacent windings of the stator coils does not assume significant values even during voltage pulses with very high flank steepness. The reason is that these voltage pulses in adjacent stator coils propagate in the same direction, i.e. radially outwardly or radially inwardly, and a flank is situated at the same radial position in both stator coils at the same time. The risk of electrical flashover between the stator coils, in particular in the region on the end faces of the stator or at the winding head, is therefore low. A potential difference between adjacent stator coils of the same phase which are electrically connected in parallel is thus zero or approximately zero at a specific radial position, even during rapid transient processes as may occur in modern converters.

Electrical conductors belonging to adjacent stator coils of the same phase are in each case formed substantially helically and extend, starting from a connection point of the parallel circuit, radially in the same direction with respect to a rotational axis of the stator base body. In other words, electrical conductors which are belonging to adjacent stator coils of the same phase are in each case formed substantially helically, and a radial component of a longitudinal extent of the electrical conductor relative to a rotational axis of the stator base body is oriented in the same way starting from a connection point of the parallel circuit.

Radially inner connections and radially outer connections of the adjacent stator coils of the same phase may in each case be electrically connected together, in particular directly connected together. The connections of adjacent stator coils of the same phase may have a common or separate star points.

The above embodiments and refinements of the invention may be combined in arbitrary fashion.

### BRIEF DESCRIPTION OF THE FIGURES

The present invention is explained in more detail below with reference to the exemplary embodiment shown in the schematic figure of the drawing. The drawing shows:

FIG. 1 a schematic half-sectional view of an exemplary electrical machine;

FIG. 2 a front view of the stator base body of the electrical machine from FIG. 1;

FIG. 3 a detail view of a section through the stator;

FIG. 4 a schematic illustration of a stator coil wound clockwise;

FIG. 5 a schematic illustration of a stator coil wound counter-clockwise;

FIG. 6 the stator coil from FIG. 4 in a technically conventional depiction;

FIG. 7 the stator coils from FIGS. 4 and 5 in a technically conventional depiction;

FIG. 8 a circuit diagram of an exemplary stator of an electrical machine;

FIG. 9 the circuit diagram from FIG. 8 supplemented with symbolic depictions of the stator coils; and

FIG. 10 an electrical machine with a stator of the proposed type which is installed in a vehicle.

### DETAILED DESCRIPTION OF THE INVENTION

Initially, it is stated that identical parts in the different embodiments carry the same reference signs or same component designations, but in some cases with different indices. The disclosures of a component contained in the description may accordingly be transferred to another component with the same reference sign or same component designation. Also, the positional data selected in the description, such as e.g. “top”, “bottom”, “rear”, “front”, “side” etc. relate to the figure directly described and depicted, and on a position change, should be transferred accordingly to the new position.

FIG. 1 shows a half section through a schematically depicted electrical machine 1. The electrical machine 1 comprises a shaft 2 with a rotor 3 sitting thereon, wherein the shaft 2 is mounted by means of (roller) bearings 4a, 4b so as to be rotatable about a rotational axis A relative to a stator 5. In this example, the stator 5 has several stator plates 6 which form a stator plate packet or stator base body 7, and a stator winding 8 arranged therein. In concrete terms, the first bearing 4a sits in a front end shield 9, and the second bearing 4b sits in a rear end shield 10. Furthermore, the electrical machine 1 comprises a (middle) housing part 11 which connects the front end shield 9 and rear end shield 10 and also receives the stator base body 7. The front end shield 9, the rear end shield 10 and the housing part 11 in this example thus form the housing 12 of the electrical machine 1.

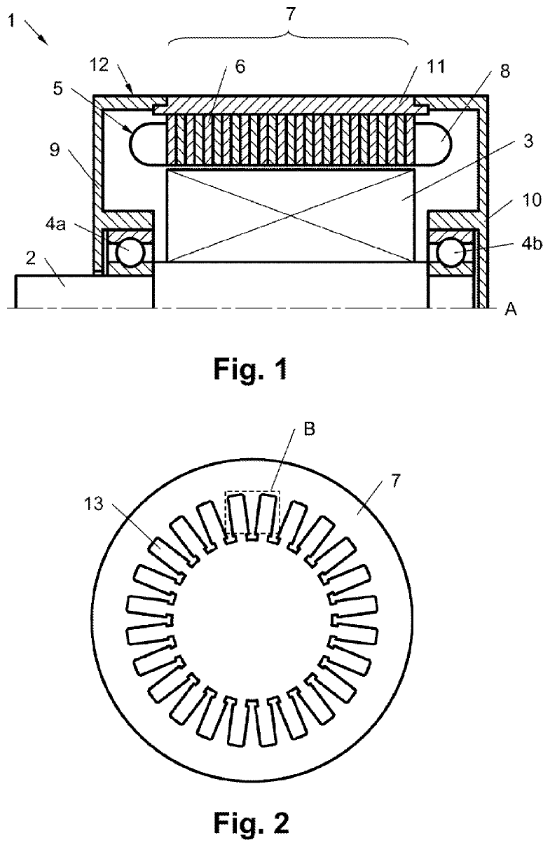

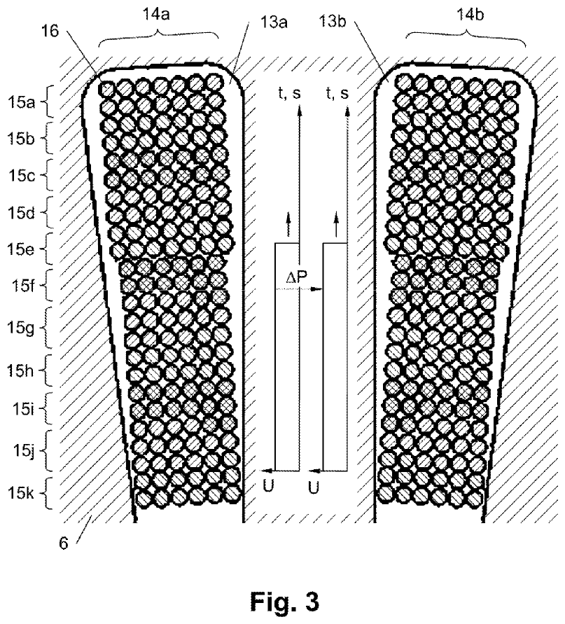

FIG. 2 now shows a front view of a stator base body 7, in this case without stator winding 8. The stator grooves 13 which open radially towards the inside and receive the stator winding 8, comprising several stator coils, are clearly evident. FIG. 2 furthermore shows a region B which is illustrated in enlarged form in FIG. 3. The stator grooves 13 may in particular run in the axial direction or helically.

FIG. 3 now shows a section through the region B marked in FIG. 2, in this case with the stator coils 14a, 14b of the stator winding 8 arranged in the stator grooves 13a, 13b. Each of the stator coils 14a, 14b has several windings 15a . . . 15k, which are hatched in different ways for clearer distinction. Each of the windings 15a . . . 15k in turn consists of several coil wires 16, in this case ten coil wires 16. However, a different number of windings 15a . . . 15k and coil wires 16 may also be provided.

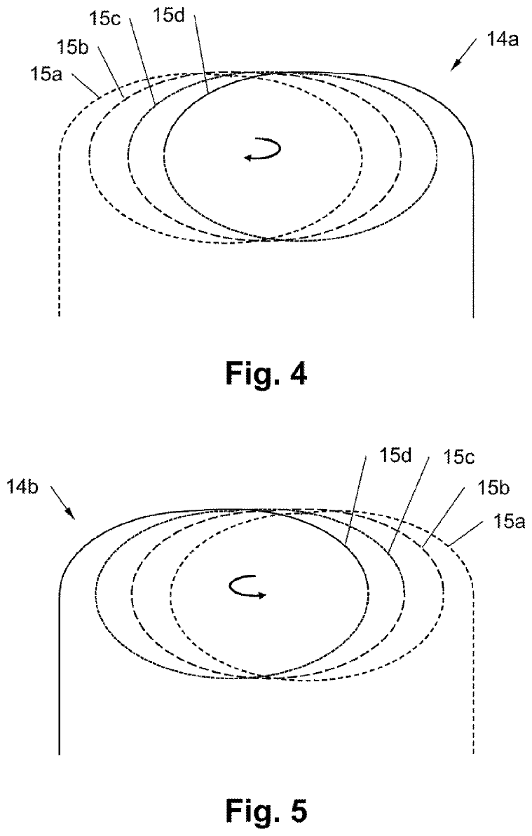

FIG. 3 shows in each case a half of the stator coils 14a, 14b, in this case a right half of the stator coil 14a and a left half of the stator coil 14b. The stator coils 14a, 14b have different winding directions, as illustrated in FIGS. 4 and 5. The stator coil 14a illustrated symbolically in FIG. 4 is wound clockwise, and the stator coil 14b illustrated symbolically in FIG. 5 is wound counter-clockwise. Accordingly, the coil wires—roughly speaking—are arranged with a left-hand or right-hand pitch. For greater clarity, only four windings 15a . . . 15d are depicted symbolically in FIGS. 4 and 5 with different line styles.

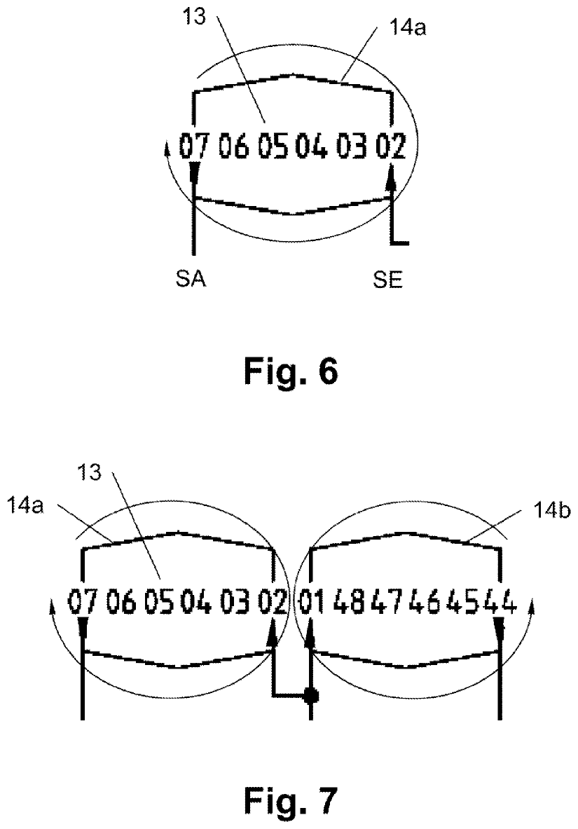

FIG. 6 shows the stator coil 14a and its arrangement in the stator grooves 13 in the technically generally conventional notation. In concrete terms, the stator coil 14a is shown in the form of a hexagon, and the stator grooves 13 are numbered with figures. Also, the coil input SE and the coil output SA are marked.

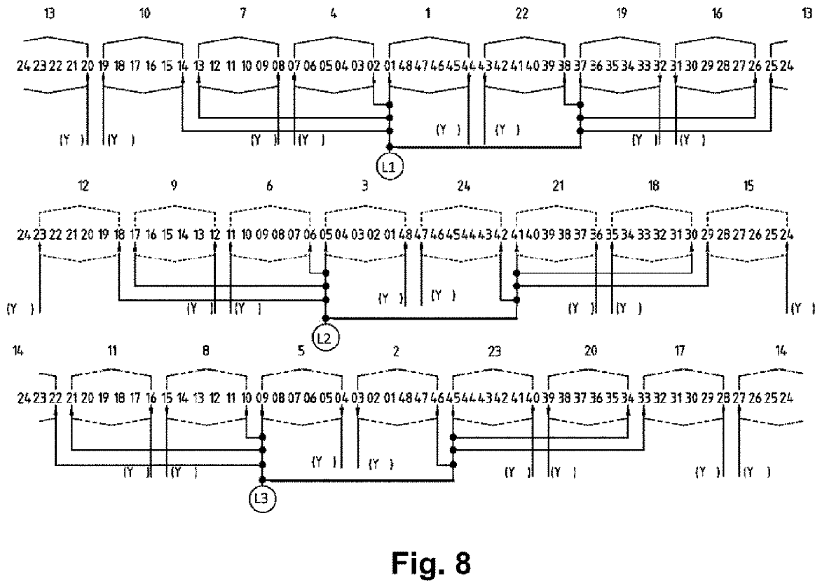

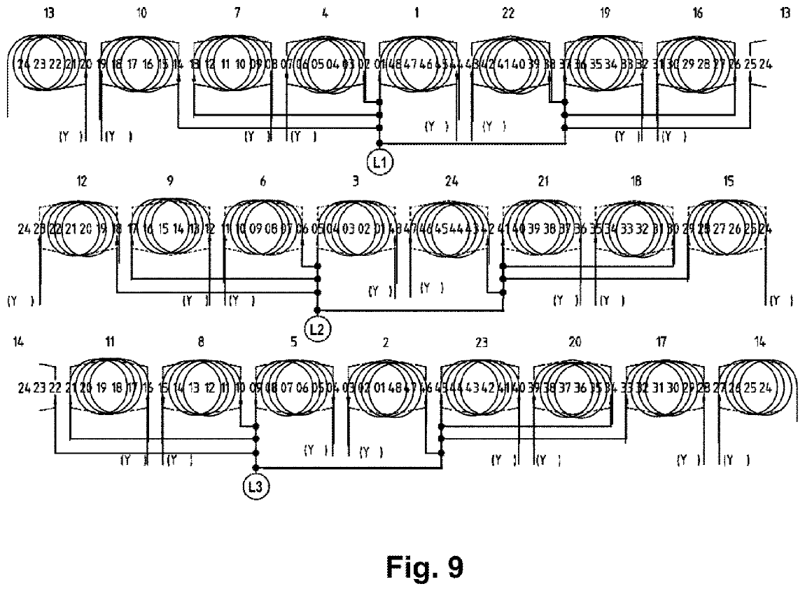

FIG. 7 shows the coil pair formed by the stator coils 14a and 14b in the technically generally conventional notation. As evident from FIG. 7, the stator coils 14a, 14b are electrically connected in parallel and occupy the stator grooves 13 numbered “01”, “02”, “07” and “44”. Accordingly, FIG. 3 shows the stator groove 13a numbered “02” and stator groove 13b numbered “01”. Because of the parallel connection, the stator coils 14a, 14b are assigned to a phase L1 of a plurality of phases L1 . . . L3 of the electrical machine 1 (see also FIGS. 8 and 9).

FIG. 8 shows an exemplary winding diagram or circuit diagram of an eight-pole single-layer winding with 48 stator grooves 13. The stator coils 14a, 14b are also numbered. FIG. 9 finally shows the winding diagram or circuit diagram in FIG. 8 supplemented with the symbolic windings 15a . . . 15k.

Thus a stator 5 for an electrical machine 1 is disclosed, which comprises an annular stator base body 7 with stator grooves 13, 13a, 13b which are open towards the inside, and stator coils 14a, 14b which are arranged in the stator grooves 13, 13a, 13b and are assigned to a plurality of phases L1 . . . L3 of the electrical machine 1. Adjacent stator coils 14a, 14b of the same phase L1 are here contra-wound and electrically connected in parallel. In particular, the radially inner connections of the stator coils 14a, 14b and the radially outer connections of the stator coils 14a, 14b of the same phase L1 are in each case electrically connected together. A power supply connected to phase L1 therefore produces a current flow with different winding direction in the stator coils 14a, 14b. In particular, as is the case here, all adjacent stator coils 14a, 14b of the same phase L1 or L2 or L3 are contra-wound and electrically connected in parallel.

This gives the advantage that the potential difference between adjacent windings 15a . . . 15k of the stator coils 14a, 14b does not assume a significant value even during voltage pulses with very high flank steepness. This is because these voltage pulses in adjacent stator coils 14a, 14b propagate in the same direction, i.e. radially outwardly or radially inwardly, and a flank is situated at the same radial position in both stator coils 14a, 14b at the same time. The risk of electrical flashover between the stator coils 14a, 14b, in particular in the region on the end faces of the stator 5 or at the winding head, is therefore low.

FIG. 3 shows for each stator winding 14a, 14b a voltage-travel diagram U/s and a voltage-time diagram U/t. The diagram shows that a flank of a voltage pulse propagates radially outwardly from the coil input SE, and the same electrical voltage is present at a specific radial position in both stator windings 14a, 14b at a specific time t. A potential difference ΔP at a specific radial position is zero or approximately zero even during rapid transient processes as may occur in modern converters.

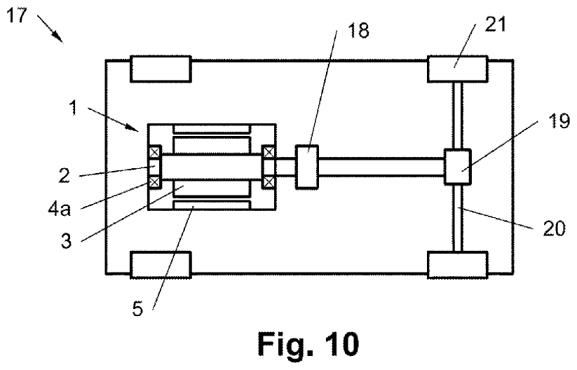

FIG. 10 finally shows an electrical machine 1 installed in a vehicle 17. The vehicle 17 has at least two axles, at least one of which is driven. In concrete terms, the electric motor 1 is connected to an optional gear mechanism 18 and a differential gear 19. The half shafts 20 of the rear axle adjoin the differential gear 19. Finally, the driven wheels 21 are mounted on the half shafts 20. The drive of the vehicle 17 is provided at least partially or for part of the time by the electrical machine 1. This means that the electrical machine 1 may serve for solely driving the vehicle 17, or for example may be provided in conjunction with an internal combustion engine (hybrid drive).

Finally, it is established that the scope of protection is determined by the patent claims. The description and the drawings should however serve as reference for interpretation of the claims. The features contained in the figures may be interchanged and combined with one another arbitrarily. In particular, it is also established that the devices depicted may in reality comprise more or also fewer constituents than illustrated. In some cases, the illustrated devices or their constituents may also not be depicted to scale, and/or may be enlarged and/or reduced.

1. A stator for an electrical machine, comprising:
an annular stator base body with a plurality of stator plates and stator grooves which are open towards the inside, and stator coils of a stator winding which are arranged in the stator grooves and assigned to a plurality of phases of the electrical machine,
wherein adjacent stator coils of the same phase are contra-wound and electrically connected in parallel.

2. The stator according to claim 1, wherein radially inner connections and radially outer connections of the adjacent stator coils of the same phase are in each case electrically connected together directly connected together.

3. The stator according to claim 2, wherein the connections of the adjacent stator coils of the same phase have a common or separate star points.

4. The stator according to claim 1, wherein electrical conductors belonging to adjacent stator coils of the same phase are in each case formed substantially helically and extend, starting from a connection point of the parallel circuit, radially in the same direction with respect to a rotational axis of the stator base body.

5. An electrical machine with a rotor which is mounted rotatably with respect to a stator about the rotation axis of the rotor, wherein the stator is configured according to claim 1.

6. A drive arrangement comprising:
an electrical machine according to claim 5; and
a power supply connected to the stator winding,
wherein the power supply is configured to provoke a current flow with different winding direction in the adjacent stator coils of the same phase which are contra-wound and electrically connected in parallel.

7. A vehicle with at least two axles, of which at least one is driven, wherein said drive is provided at least partially or for part of the time by the electrical machine according to claim 6.
